(19) United States
(12) Patent Application Publication
(10) Pub. No.: US 2004/0048639 A1
(43) Pub. Date: Mar. 11, 2004

(54) Neck phone leather bag and accessories, including strap, front cell phone pocket with speaker vents, cell phone with a specially designed flexible microphone, earphone, and speaker phone, handheld computers, games, and pagers

(76) Inventor: Christophe Obolo, Milwaukee, WI (US)

Correspondence Address: Christophe Obolo, Unit #4, 138 Woodside Green, Stamford, CT, 06902, US

(21) Appl. No.: 10/152,114

(22) Filed: May 20, 2002

(51) Int. Cl. H04B 1/034; H04B 1/08; H04M 1/00; H04B 1/38

(52) U.S. Cl. 455/575.1; 455/100; 455/351; 455/569.1

(57) ABSTRACT

Neck bag and accessories is a convenient and practical way of enjoying modem age technologies, including cell phones, pagers, handheld computers, and computer games without overloading your backpacks, waists, and pockets. Neck bag and accessories, when used with a specifically designed cell phone will allow one to talk and attend to other tasks such as driving, using a wheelchair, rock climbing, gardening, cleaning or simply working. The flexible microphone/speakerphone and the earphone assure additional comfort that bring privacy, confidence, and accuracy in almost whatever you are doing with your hands. It really works! This invention allowed me to talk to my pregnant girlfriend for hours without straining my hands, ears, attention and relationship. The neck bag is simply a leather bag with a strap, front device pocket for a cell phone pocket or handheld computer or computer game and pager pockets.

### BACKGROUND OF THE INVENTION

Neck bag and accessories pertains to the field of cell phones, handheld computers, pagers, computer games portability, use, and interference with daily living activities.

### BRIEF SUMMARY OF INVENTION

Neck bag and accessories pertains to hand-free use of cell phones when driving, walking, cleaning properties, cooking, working, reading or simply relaxing. This invention relates to cell phone, handheld computers, games, and pager portability and accessibility to people while they are doing other things. For example, female physician often have difficulties carrying pagers, handheld computers, and cell phone when wearing Dresses to work.

They often rely on extra pockets in their white professional coats, which is not always practical. Motorists are often involved in many road accidents due to Distractions brought on by holding and talking while driving. Neck phone and accessories is a line of products that will enable people to even tend their garden while talking.

### BRIEF DESCRIPTION OF THE SEVERAL VIEWS OF THE DRAWINGS

### Drawing Page 1

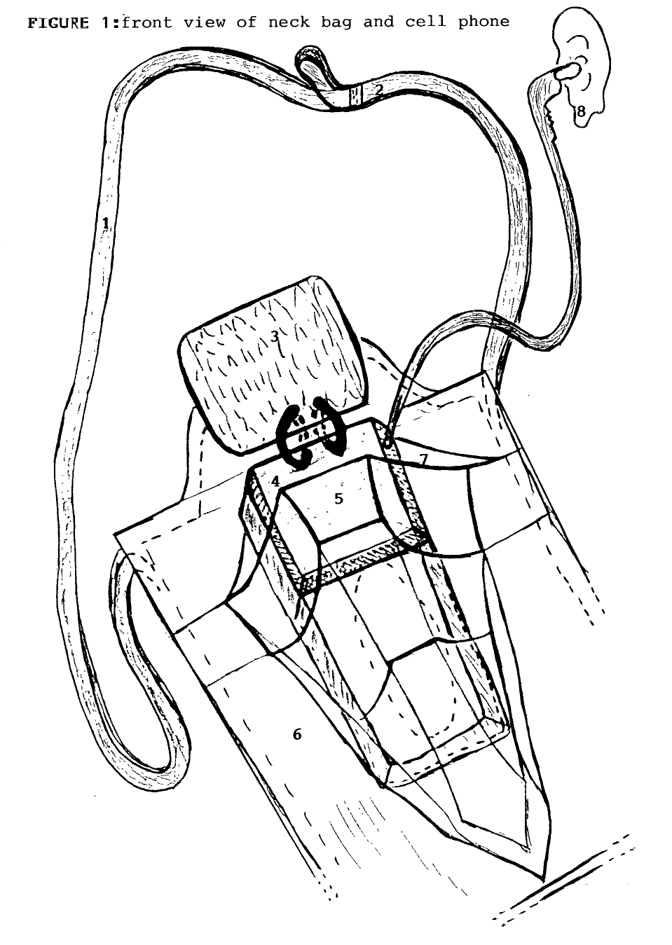

FIG. 1: front view of neck bag and cell phone Bag and accessories, including a neck strap, earphone and earphone outlet, a cell phone in vented leather front pocket and flip up microphone.

1. Strap

2. Security buckle

3. Flip up microphone/Speaker

4. Cell phone

5. Neck bag pocket

6. Neck phone bases

7. Earphone outlet

8. Earphone line

### Drawing Page 2

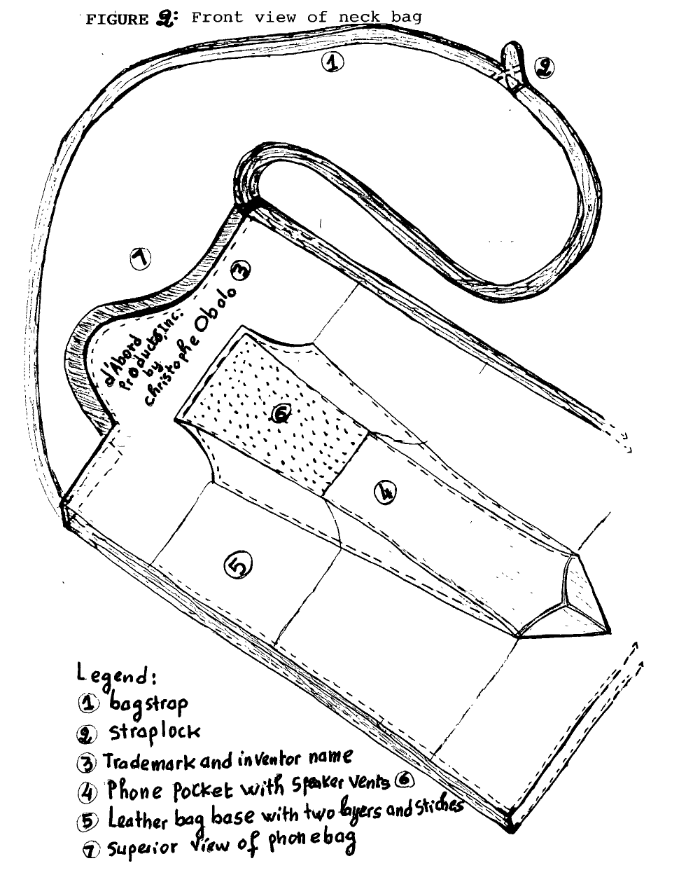

FIG. 2: Superior view Superior view of neck phone bag only with following:

1. Cell phone pocket and vents for speaker phone

2. Security buckle

3. Designer/inventor name and trademark

4. Cell phone pocket and vents for speakerphone

5. Neck bag

6. Phone pocket vents

7. Superior view of neck bag

### Drawing Page 3

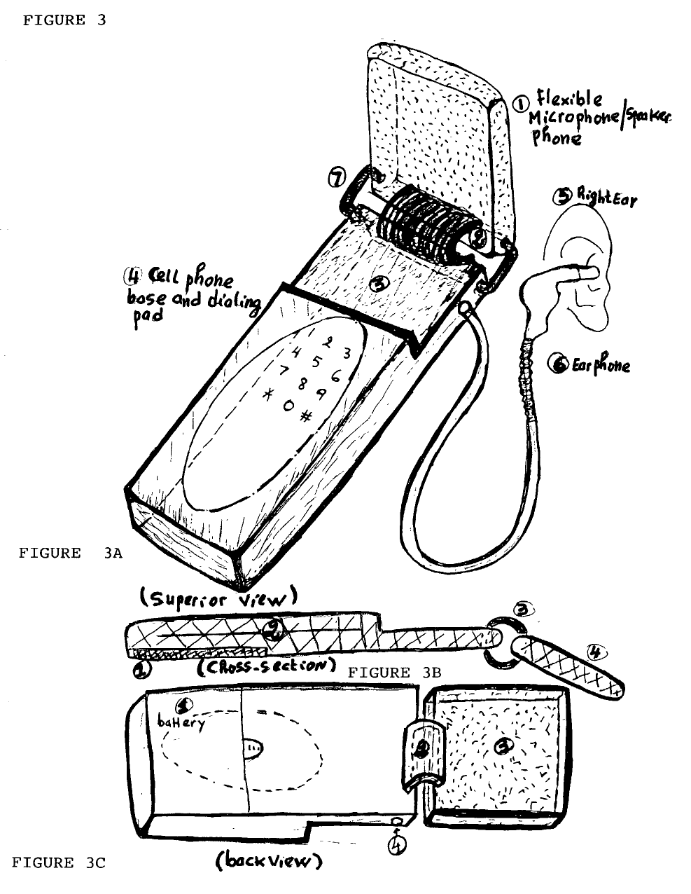

FIG. 3: cell phone multiple views

1. FIG. 3A: Superior view of cell phone and flexible microphone/speakerphone (1) with hinge (2), speakerphone (3) attached to cell phone body and dialing pad (4), (and earphone (5) in right ear (6)

2. FIG. 3B: Cross-section of cell phone body with battery chamber (1) and dialing pad (2), hinge (3), and microphone/speaker phone (4)

3. FIG. 3C: Back view of cell phone revealing battery pocket (1), hinge (2), and microphone/speakerphone (3)

### Drawing Page 4

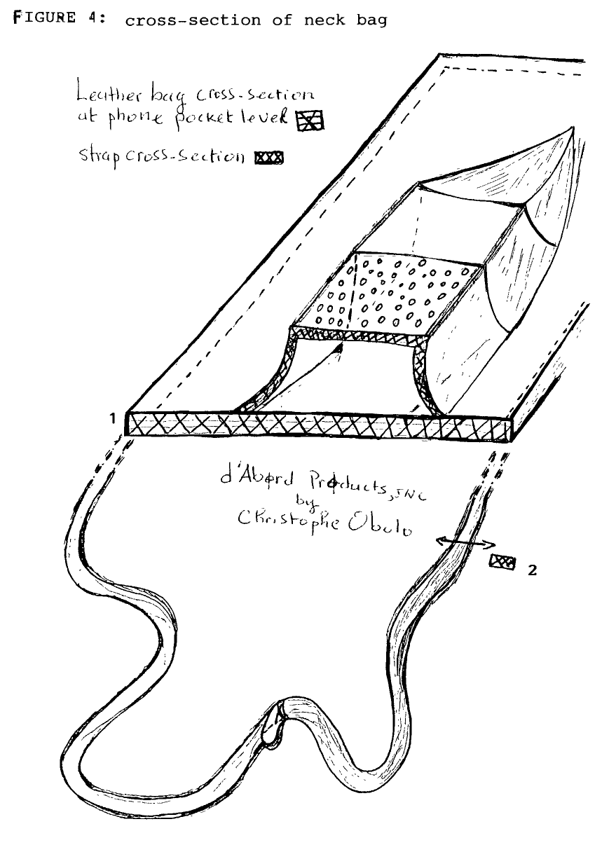

FIG. 4: cross-sections of leather bag

1. Horizontal cross-section of neck phone bag with phone pocket revealing a three-layered leather base

2. Horizontal cross-section of neck phone strap

3. Phone pocket with speakerphone vents

### Drawing Page 5

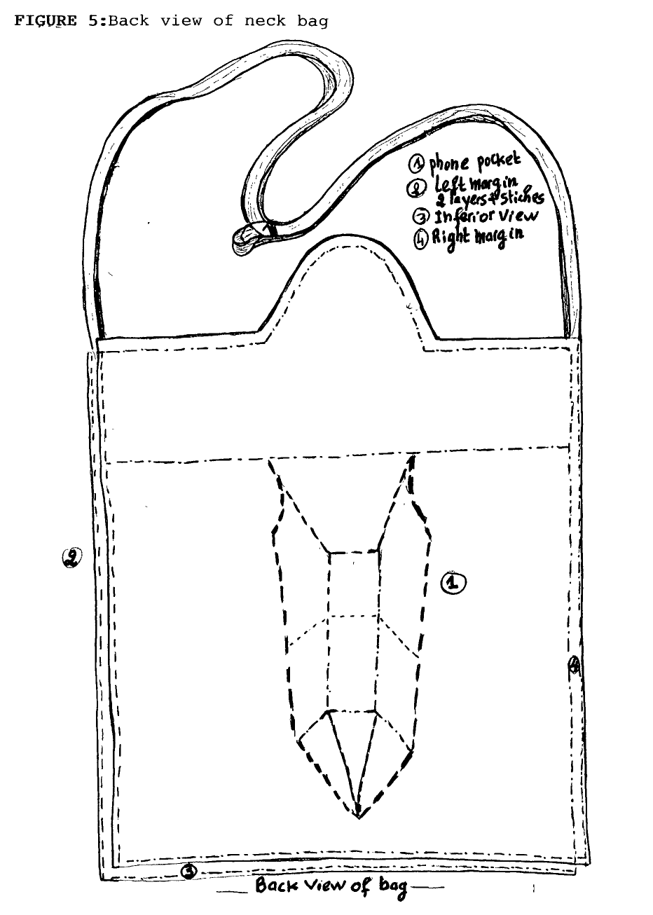

FIG. 5: Back view

1. Inside view of phone pocket specially illustrated from back

2. Stitches

3. Inferior view

4. Right margin

5. Neck phone bag with strap

6. Buckle

### Drawing Page 6

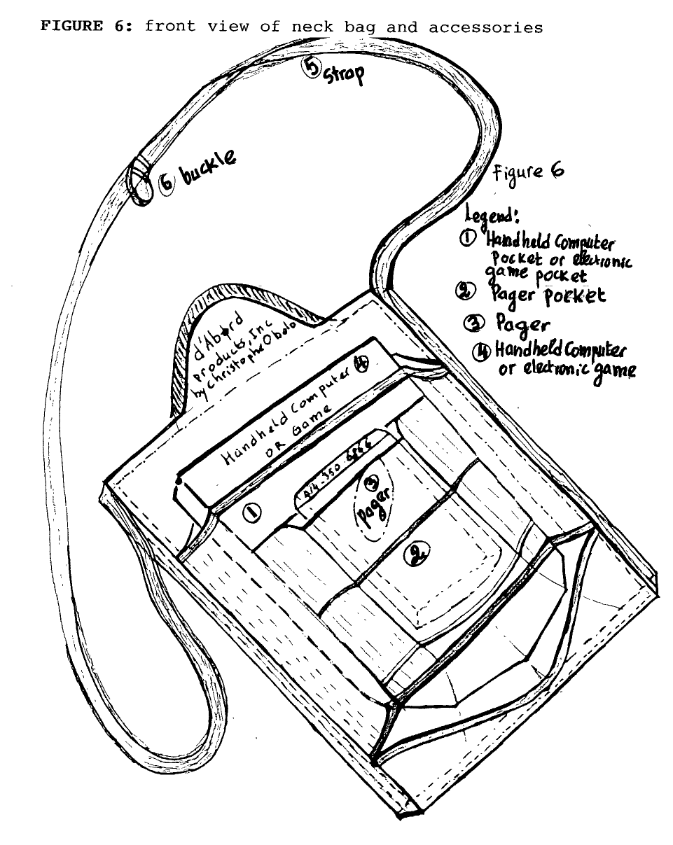

FIG. 6: Front view of neck bag and accessories

1. Handheld computer pocket

2. Pager pocket

3. Pager

4. Handheld computer or electronic games

5. Leather strap

6. Buckle

### Drawing Page 7

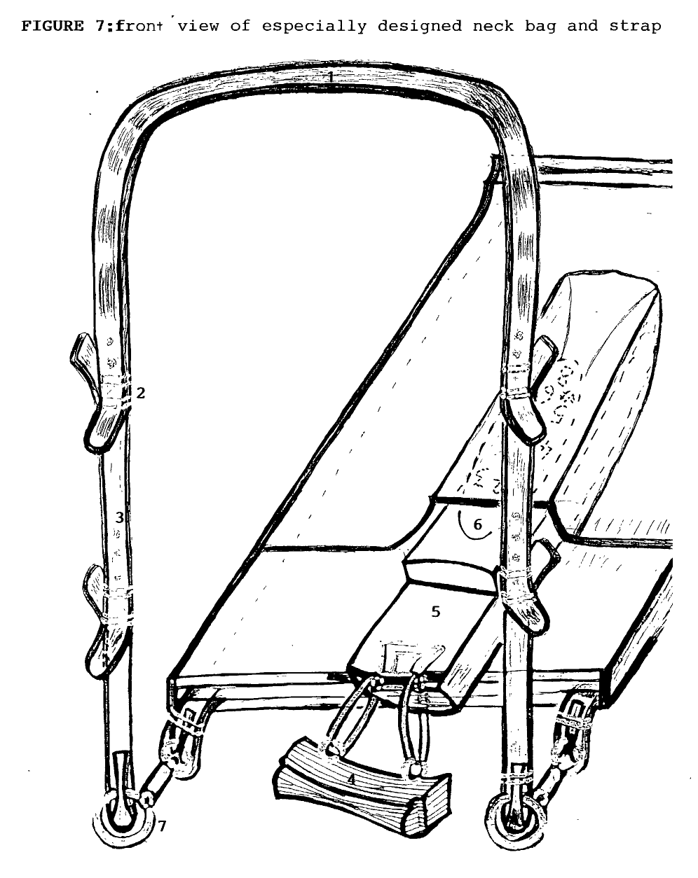

FIG. 7: Front view of an especially designed elegant strap made out of pure leather

1. Leather strap with two adjustable bilateral buckles to increase elegance and decrease weight

2. Neck collar

3. Removable portion of neck strap to accommodate special needs and length

4. Microphone/speakerphone

5. Microphone/Speakerphone chamber

6. Dialing pad

7. Flexible metal hinge between strap and neck bag

### Drawing Page 8

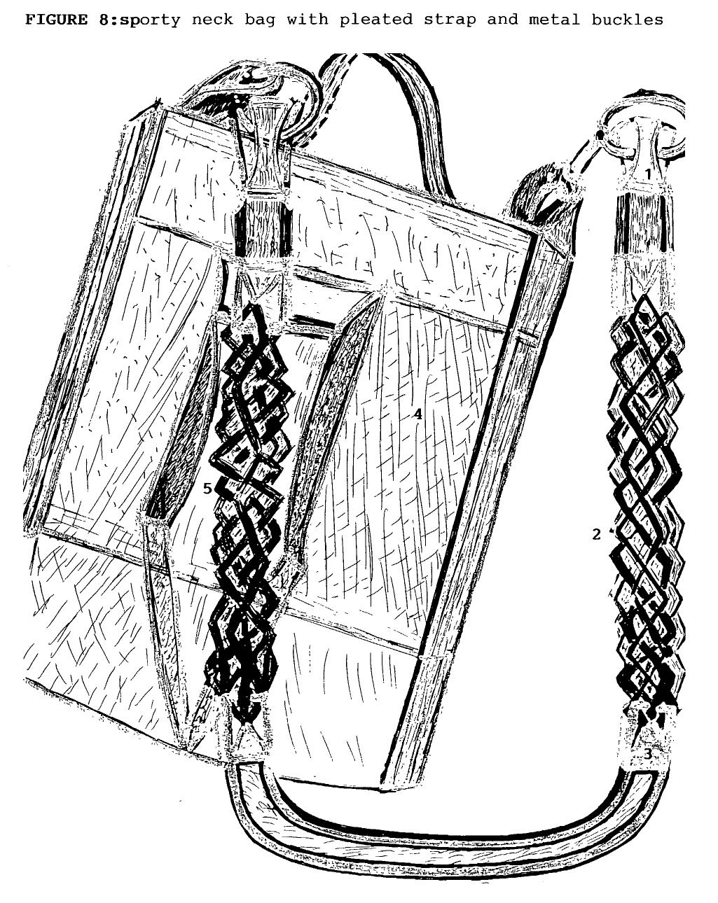

FIG. 8: Front view of a sporty pleated neck strap

1. Metal Hinge and buckles securing neck bag to strap

2. A bag strap especially designed for men and/or sporty look

3. Ornamental metal buckles

4. Neck bag base

5. Pleated strap made from pure leather

### DETAILED DESCRIPTION OF INVENTION

The neck bag and accessories is an invention that emphasizes the portability of Compact technologic items, including cell phones, handheld computers, pagers, and/or electronic games by modifying the front pocket and/or adding additional pockets for specific items. The basics of this invention are simple but exciting.

The neck bag will consist of the following:

1. A 7×5 in. two or three-layered leather base FIGS. 2 and 4, this bag will rest on the chest and will be supported by

2. A leather strap or necklace for wearing around neck, All figures

3. A device pocket for specific items, e.g. cell phone or handheld computer

4. Front vents for microphone/speaker phone, FIG. 2

5. A security buckle on the strap, all figures

Neck bag accessories will consist of the following:

1. Cell phone with flexible microphone FIGS. 3A1, 3B4, 3C3 that will fit in the front pocket and work as a speakerphone when flipped up, FIG. 3A1. The microphone will function as a regular microphone when confined to its bed FIG. 3A3 on the phone body and will be used in conjunction with an earphone FIG. 3C4 for best communication.

2. A unilateral earphone FIG. 3A

3. A earphone outlet on one side of phone body

4. Microphone is attached to phone body by a hinge FIG. 3A2 or an hinge alternative FIG. 3A7

5. A dialing pad FIG. 3A4

6. A battery pocket in the back FIG. 3C1

7. The neck bag will be stitched together by sewing and gluing. The strap buckle will be made of leather or plastic. The neck bag will be entirely made of light weighed leather.

8. The cell phone pocket FIGS. 2,4,5 will be primarily designed to carry a compact cell phone, but this pocket can be modified to carry a handheld computer, a pager, or a computer game. A multipurpose Neck bag capable of carrying a cell phone, handheld computer, and pager will also be available depending on the market and demand.

What I claim as my invention is:

1. Convenience, accessibility, and portability, from neck bag, of electronics such as:
A cell phone, or a handheld computer or game and a pager from a specially designed 7×5 in. neck bag

2. Portability and use of a specially designed cell phone fitted in a neck bag
With a flip up microphone that can work as a speakerphone and an earphone, fitted in the neck bag and stay hands free and attend other tasks and avoid driving accidents and straining of hands from holding cell phone for hours.
